(19) United States
(12) Patent Application Publication
(10) Pub. No.: US 2004/0078209 A1
(43) Pub. Date: Apr. 22, 2004

(54) Method and apparatus for on-site enterprise associate and consumer matching

(76) Inventor: Rodney A. Thomson, Westminster, CO (US)

Correspondence Address: Bradley M. Knepper, SHERIDAN ROSS P.C., Suite 1200, 1560 Broadway, Denver, CO, 80202-5141, US

(21) Appl. No.: 10/278,462

(22) Filed: Oct. 22, 2002

(51) Int. Cl. G06F 17/60

(52) U.S. Cl. 705/1; 705/14

(57) ABSTRACT

A system for matching consumers to associates at an enterprise site is provided. The system includes a wireless enterprise network in communication with a consumer wireless device. In response to a request for assistance entered by a consumer, the consumer may be directed from their current location to a location at which the requested item or service may be obtained. The system may also be used to assign an available associate to assist the consumer. An appropriate associate may be selected based on various criteria, including the position of the associate relative to the consumer and whether the associate has the qualifications necessary to meet the consumer's requirements.

### FIELD OF THE INVENTION

The present invention relates to providing appropriate assistance to consumers at an enterprise site. In particular, the present invention relates to detecting the presence and requirements of a consumer at an enterprise site, and allocating resources to address the consumer's requirements.

### BACKGROUND OF THE INVENTION

At present, enterprises do not have an automated means for matching consumers with associates while both are at an enterprise site (for example at a retail outlet). Furthermore, consumers and associates are not matched based on associate capability sets, consumer qualifiers, the work loads of individual associates, the location of the consumer, and the consumer's needs. Instead, it is left to the consumer and/or the associate to find the best match between the consumer's needs and qualifiers, such as language, and an associate's capability set. Further complicating the task of matching a consumer to an appropriate associate is the lack of information regarding the location of associates with capability sets that match the consumer's needs and qualifiers.

In a typical retail establishment, a consumer requiring assistance must locate an available associate. The available associate may then either assist the consumer, or find another associate having a capability set matching the consumer's needs and qualifiers. If a consumer is fortunate, an available associate having the required capability set can be found with minimal delay and effort. However, often times a consumer will experience difficulty in locating an available associate capable of assisting the consumer. Such difficulty may arise not only from difficulty in finding an associate that is not already engaged in assisting another consumer, but also from the behavior of the other consumers. That is, consumers who are more aggressive in seeking out an associate will usually receive assistance before more docile consumers, even though the more aggressive consumer may have been waiting a shorter period of time for assistance.

As a result of the inefficiencies and occasional ineffectiveness of the prevailing method for matching consumers to associates, consumers may sometimes become frustrated and leave the enterprise site without making a purchase. In addition, a consumer's frustrated attempts to obtain assistance often results in unsatisfied consumers, who are less likely to revisit an enterprise site or associated sites.

### SUMMARY OF THE INVENTION

The present invention is directed to solving these and other problems and disadvantages of the prior art. Generally, according to the present invention, the presence of a consumer at an enterprise site is automatically detected. Detection of the consumer may be performed in connection with a consumer wireless device that is either brought to the enterprise by the consumer, or picked up and activated by the consumer upon entering the site. Using the wireless device, the consumer may indicate a need for assistance. Assistance may then be provided to a consumer either through the wireless device, or by directing an available associate to the consumer.

In accordance with a further embodiment of the present invention, the location of a consumer within an enterprise site is detected. Responses to a consumer's request for assistance may be guided by the consumer's location within the site. For example, a consumer standing in a particular area of an enterprise site may initially be offered help topics that pertain to items in that area. As a further example, only a nearby associate may be dispatched to assist or greet the consumer. In addition, the consumer may be directed to an appropriate area of the enterprise site from the consumer's present location when the consumer requires assistance in locating a particular item.

In accordance with still another embodiment of the present invention, the assistance provided to the consumer is informed by profile information associated with that consumer. For example, a consumer may indicate a preference or a need to speak with an associate in a particular language by making an appropriate selection using the consumer wireless device. After detecting the consumer's indicated preference, only those associates having the required language skills may be placed in contact with the consumer. Consumer preferences or requirements may also be obtained from consumer profile information stored in the consumer wireless device or in a database maintained by, or for, the enterprise. For instance, a consumer profile may contain required or preferred language information. In addition, the profile information may contain data concerning the consumer's past buying habits and preferences, and the assistance provided to the consumer may be tailored to those habits or preferences.

In accordance with still another embodiment of the present invention, information may be pushed to a consumer based on profile information obtained from selections made by the consumer or maintained in a consumer profile. For example, a consumer who purchased a particular item during an earlier visit to the enterprise site (or an associated enterprise site) may be given suggestions regarding complementary items available for purchase.

In accordance with an embodiment of the present invention, a system for matching a consumer to an associate at an enterprise site is provided. The system may include a consumer wireless device carried by a consumer while visiting the site. In addition, the system may include a wireless enterprise network infrastructure, permitting communications between an enterprise server and the consumer wireless device, and allowing the location of the consumer wireless device to be determined, at least while the consumer is at the enterprise site. The system may additionally include an associate wireless device in communication with the enterprise server through the wireless network infrastructure. Location information obtained from the associate wireless device in relation to the wireless infrastructure may be utilized in selecting an associate to dispatch to a consumer or to direct an associate to the location of a consumer requiring assistance. For instance, a nearby associate having the required capabilities may be directed from the associate's present location to the location of a consumer. The system may also be used to direct a consumer requiring assistance to a qualified enterprise associate. The system may additionally include an enterprise site database containing, for example, the location of particular items within the site, and information regarding items and services available from the enterprise.

These and other advantages and features of the invention will become more apparent from the following description of an illustrative embodiment of the invention, particularly when taken together with the accompanying drawings.

### BRIEF DESCRIPTION OF THE DRAWINGS

FIG. 1 is a block diagram of a wireless on-site enterprise system in accordance with an embodiment of the present invention;

FIG. 2 is a block diagram of a wireless device in accordance with an embodiment of the present invention;

FIG. 3 is a block diagram of an enterprise server in accordance with an embodiment of the present invention;

FIG. 4 is a flow chart depicting the operation of a wireless on-site enterprise system in connection with a consumer wireless device in accordance with an embodiment of the present invention; and

FIG. 5 is a flow chart depicting the operation of a wireless on-site enterprise system in providing assistance to a consumer in accordance with an embodiment of the present invention.

### DETAILED DESCRIPTION

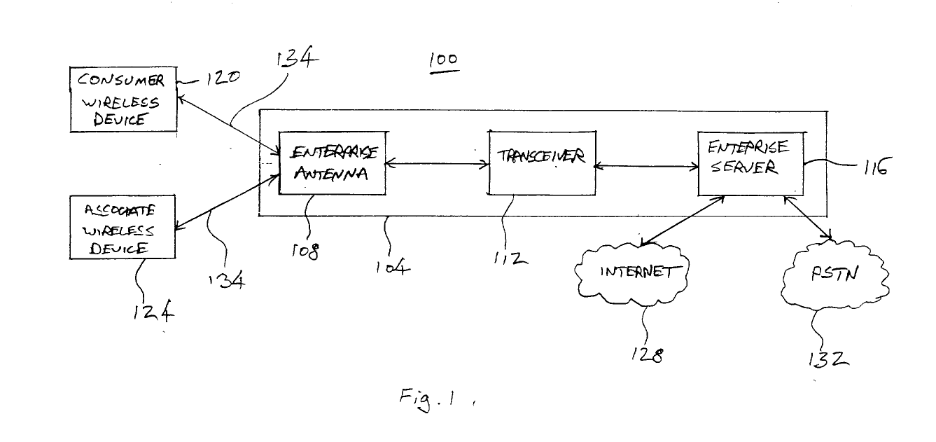

With reference now to FIG. 1, a wireless on-site enterprise system 100 is shown. In general, the wireless on-site enterprise system 100 comprises an enterprise network infrastructure 104 that generally includes an enterprise antenna 108, a transceiver 112, and an enterprise server 116. The enterprise network infrastructure 104 may be in communication with a consumer wireless device 120. In addition, the enterprise network infrastructure 104 may be in communication with an associate wireless device 124. The enterprise network infrastructure 104 may additionally be interconnected to the Internet 128 and/or to the public switched telephony network (PSTN) 132.

The enterprise antenna 108 may comprise a plurality of antennas distributed throughout the enterprise site. In general, the enterprise antenna 108 is any device suitable for establishing a wireless communication link 134 between a consumer wireless device 120 and/or an associate wireless device 124 and the enterprise network infrastructure 104. Accordingly, the enterprise antenna 108 may comprise a radio frequency antenna or an optical frequency emitter and detector (for example in connection with an infrared communication system). The transceiver 112 generally serves to provide signals for transmission by the enterprise antenna 108 based on signals received from the enterprise server 116, for example by modulating a carrier signal. In addition, the transceiver 112 receives signals from the enterprise antenna 108. The transceiver 112 may then, for example, demodulate the received signals and provide the received data signals to the enterprise server 116. The enterprise server 116 may include any general purpose server type computer. Furthermore, the enterprise server 116 may comprise a communication server for operatively interconnecting the enterprise network infrastructure 104 to the Internet 128 and/or the public switched telephony network 132. An example of a suitable communication server is the DEFINITY®/MultiVantage™ server available from the assignee of the present invention. Alternatively or in addition, the enterprise server 116 may comprise a contact center server. An example of a contact center server is the Avaya™ Multimedia Contact Center or Avaya™ MultiVantage™ Call Center available from the assignee of the present invention.

The consumer wireless device 120 may be any portable device that is capable of wireless communication with the enterprise network infrastructure 104. Accordingly, the consumer wireless device 120 may comprise a personal digital assistant (PDA) having wireless communication capabilities, a hand-held computer having wireless communication capabilities, a wireless telephone, or a wireless headset. Similarly, the associate wireless device 124 may comprise any portable device capable of communication with the enterprise network infrastructure 104. Thus, the associate wireless device 124 may also comprise a personal digital assistant, a hand-held computer, a wireless telephone, or a wireless headset. As can be appreciated, the wireless devices 120, 124 may use any suitable wireless network protocol for communicating with the enterprise network infrastructure 104. For example, a BLUETOOTH™, Hyperlan™, IEEE 802.11a or IEEE 802.11b (WiFi™) wireless network may be utilized.

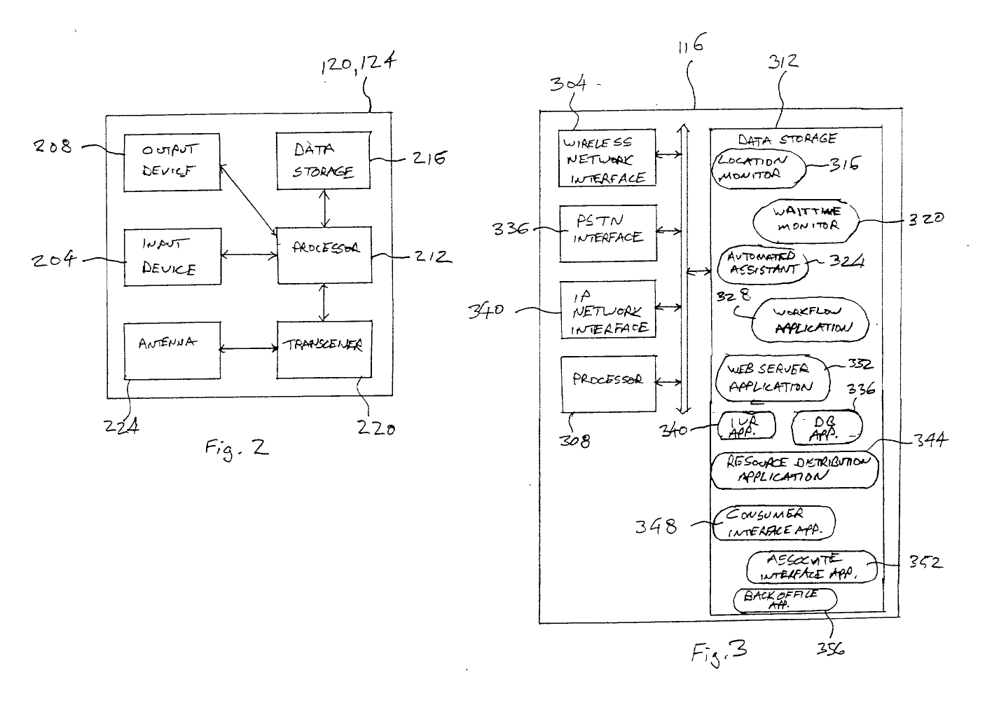

With reference now to FIG. 2, a wireless device 120, 124 in accordance with an embodiment of the present invention is illustrated in block diagram form. In general, the wireless device 120, 124 includes a user input device 204. The user input device 204 allows a user (e.g., a consumer or an associate) to enter data or make selections. Accordingly, the input device 204 may comprise a keyboard, a touch screen, a pointing device, or a microphone. The wireless device 120, 124 additionally includes a user output device 208. The user output device 208 may comprise a visual display, such as a liquid crystal display or a light emitting diode display. Alternatively or in addition, the output device 208 may comprise a speaker for audible output. Furthermore, as can be appreciated, all or certain functions of the input device 204 and output device 208 may be combined, for example in a touch screen for providing visual output and receiving user input.

The wireless device 120, 124 additionally includes a processor 212 for controlling the operation of the device 120, 124. The processor 212 may comprise a general purpose computer processor, such as a PENTIUM™ processor, a digital signal processor, or a controller. The processor 212 may operate in connection with applications stored in data storage 216. In general, the data storage 216 may comprise any device capable of storing computer data. For example, the data storage 216 may comprise solid state memory (e.g., RAM or ROM), a hard disk drive, or an optical storage device. As can be appreciated, where the processor 212 comprises a controller, the data storage 216 may be integrated with the processor 212.

The wireless device 120, 124 additionally includes a transceiver 220 for formatting data for transmission received from the processor 212. The properly formatted data is then provided from the transceiver 220 to a device antenna 224. For example, the transceiver 220 may modulate a carrier signal to transmit data from the wireless device 120, 124 to the enterprise network infrastructure 104. The device antenna 224 additionally serves to receive signals transmitted by, for example, the enterprise antenna 108. The signal received by the device antenna 224 is provided to the transceiver 220, which then formats the received signal and provides the formatted signal to the processor 212. For example, the transceiver may demodulate a signal received by the device antenna 224, and the demodulated signal may be provided to the processor 212.

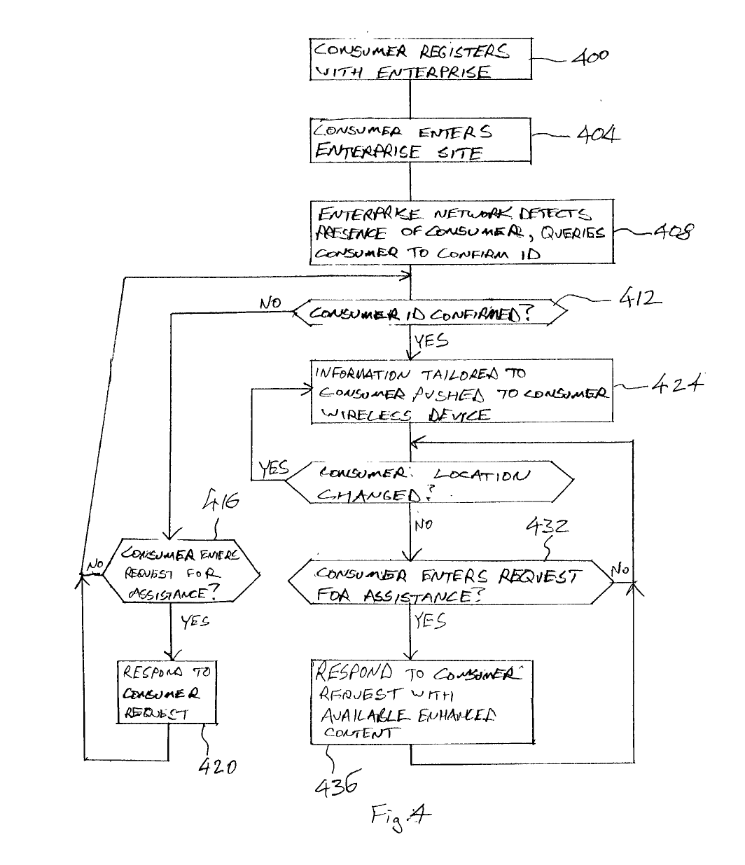

In FIG. 3, a block diagram of an enterprise server 116 in accordance with an embodiment of the present invention is illustrated. In general, the enterprise server 116 comprises a wireless network interface 304, allowing the enterprise server 116 to communicate with and implement the wireless network at the site. In particular, the wireless network interface 304 is in communication with wireless devices 120, 124 through the enterprise antenna 108 and the transceiver 112 (see FIG. 1). Accordingly, the wireless network interface 304 may implement, for example, a BLUETOOTH™, Hyperlan™, IEEE 802.11a or an IEEE 802.11b (WiFi™) wireless network.

The enterprise server 116 additionally includes a processor 308 for controlling the operation of the enterprise server 116. The processor 308 may run various application programs stored in data storage 312. The processor 308 may comprise a general purpose computer processor, such as a PENTIUM™ processor. The data storage 312 may include any computer data storage device. For example, the data storage 312 may comprise solid state memory, a hard disk drive, or an optical storage device.

Applications stored in the data storage 312 capable of running on the processor 308 may include a location monitor 316, a wait time monitor 320, an automated assistant application 324, a workflow application 328, a web server application 332, and a database 336. Separately or as part of another application (e.g. the automated assistant 324), an interactive voice recognition application 340 may be provided. An associate distribution application 344 may be provided for tracking the tasks that have been assigned to associates and to assign new tasks to the associates (e.g., dispatching an associate to a consumer), for example, in connection with a workflow application 328. A consumer interface application 348 and an associate interface application 352 may also be provided. In addition, a back-office application 356 may be provided for inventory monitoring. Not all of the above-listed applications 316-356 need be provided as part of the enterprise server 116. Furthermore, additional applications may be provided as required. In addition, it should be appreciated that the various applications need not be provided as part of a single enterprise server 116. For example, various functions may be divided between two or more server devices. Furthermore, the functions of various applications may be combined or separated into additional applications.

The location monitor 316 primarily functions to determine and track the location of consumer wireless devices 120 and associate wireless devices 124 in communication with the enterprise network infrastructure 104. In an embodiment of the present invention, the location monitor 316 is capable of locating a consumer wireless device 120 or an associate wireless device 124 within an enterprise site with sufficient resolution to determine a general area of the site at which a consumer or an associate associated with the device 120, 124 is located. According to another embodiment of the present invention, the location monitor 316 functions with sufficient precision to locate the position of a consumer wireless device 120 or an associate wireless device 124 within, for example, a particular aisle. As can be appreciated, the location monitor 316 may operate in connection with signals received from the enterprise antenna or antennas 108 and a map of the site. In yet another embodiment of the present invention, the location monitor 316 simply functions to detect the presence of a consumer wireless device 120 or an associate wireless device 124 at the enterprise site, without providing more detailed location information.

The wait time monitor 320 generally functions to monitor the time that has elapsed since a request for assistance was received from a consumer wireless device 120. The wait time monitor 320 may also function to monitor the amount of time that has elapsed since a consumer wireless device 120 initially entered into communication with the enterprise network infrastructure 104, for example in connection with an enterprise that endeavors to greet each consumer shortly after the consumer arrives at the enterprise site. The wait time monitor 320 may also function to monitor wait times at particular locations within an enterprise site. For instance, the wait time monitor may be used to ensure that consumers are moved through a check out or service area without undue delay.

The automated assistant 324 may provide interactive help to consumers or associates. The automated assistant 324 may function in response to an initial request for assistance, and may operate to provide the required assistance without, for example, connecting a consumer to a live agent through a voice link, or dispatching an associate to the consumer's location. A consumer or an associate may interact with the automated assistant 324 using voice communications, for example in connection with a voice recognition functionality and text to speech functionality, or through a menu-based, graphical format.

The workflow application 328 may control the actions taken by the enterprise in response to various conditions detected with respect to the enterprise site. The resource distribution application 344 may allocate associates between various tasks. In an embodiment of the present invention, the resource distribution application 344 may assign associates between various primary tasks, or between primary tasks and backup tasks. For example, an associate whose primary task involves stocking items may be dispatched to assist a consumer (e.g., a backup task for the associate) who has made a request for assistance when no other associates are available. As a further example, an associate may be dispatched from a previously assigned task to operate a cash register when wait times in the checkout area of the enterprise site are found to be excessive.

The web server application 332 may function to provide information in the form of web pages, for example, to consumers interconnected to the enterprise network infrastructure 104 through the Internet 128. In addition, content may be provided by the web server application 332 to a consumer wireless device 120 or an associate wireless device 124 having a compatible web browser application. The web server application 332 may also function to provide interactive functionality between the enterprise server 116 and the user of a consumer wireless device 120 or an associate wireless device 124.

The database 336 may store data used in connection with the various applications. For example, the database 336 may store profile (i.e. demographic) information regarding consumers who have provided or consented to the use of such information, including information regarding the past purchasing behavior of consumers. The database 336 may additionally include information concerning the qualifications of associates working at the enterprise site, the location of items stocked at the enterprise site, and the inventory status of items stocked at the enterprise site and any associated sites.

The interactive voice recognition application 340 may be provided as a stand alone application to service other applications associated with the enterprise network infrastructure 104. Accordingly, the voice recognition application 340 may provide output to, for example, the automated assistant application 324. Alternatively, such functions may be integrated with other applications.

The resource distribution application 344 generally functions to assign associates to tasks. For example, associates that are not engaged in assisting consumers may be assigned to stocking operations. In addition, the resource distribution application 344 may maintain queues used in connection with providing responses to consumer requests. Such queues may be established for various levels and/or types of assistance. For example, a queue may be established for consumers requiring live assistance. Live assistance may be provided by associates located at an off-site contact center who are associated with the enterprise through voice or text links that may be established between a consumer wireless device 120 and the associate via the enterprise network infrastructure 104 and the public switched telephony network 132 (or a private communication network). Similarly, consumers requiring physical assistance or otherwise requiring in-person assistance, may have their request placed in a queue for such assistance. As can be appreciated, the various queues may be tailored to the consumer's requirements. For example, queues may be established for requests involving particular subject matter or the location of the consumer within the enterprise site. As can further be appreciated, functionality provided as part of a telecommunication or multimedia type contact center may be applied in handling requests for assistance or the initiation of contact with consumers associated with a consumer wireless device 120 present at an enterprise site. An example of a resource or associate distribution application 344 is the Avaya™ Business Advocate application.

In addition, a consumer interface application 348 may be provided to provide an interface between the enterprise server 116 and the consumer wireless device 120. The consumer interface application 348 may additionally control the various other applications associated with the enterprise server 116 and/or the enterprise network infrastructure 104 in providing information to and receiving information from the consumer wireless device 120. Similarly, the associate interface application 352 may provide an interface between associate wireless devices 124 and the enterprise server 116. As can be appreciated, the consumer and associate interface applications 348, 352 may be combined, with functionalities provided to consumer wireless devices 120 being appropriately differentiated from functionalities provided to associate wireless devices 124.

The enterprise server 116 may additionally include a public switched telephony network (PSTN) interface 336. The PSTN interface 336 operates to place the enterprise server 116 in communication with the public switched telephony network 132 (see FIG. 1). Accordingly, the enterprise server 116 may function as a contact center server. Furthermore, through the PSTN interface 336, a wireless device 120, 124 may conduct communications over the public switched telephony network 132.

The enterprise server 116 may also include an Internet protocol (IP) network interface 340. The IP network interface 340 functions to place the enterprise server 116 in communication with the Internet 128 (see FIG. 1). Accordingly, the enterprise server 116 may comprise a web server. In addition, through the IP network interface 340, the enterprise server 116 may provide information, for example in the form of web pages, to devices via the Internet 128 (see FIG. 1). The IP network interface 340 may also be utilized to place a wireless device 120, 124 in communication with a resource available on the Internet 128.

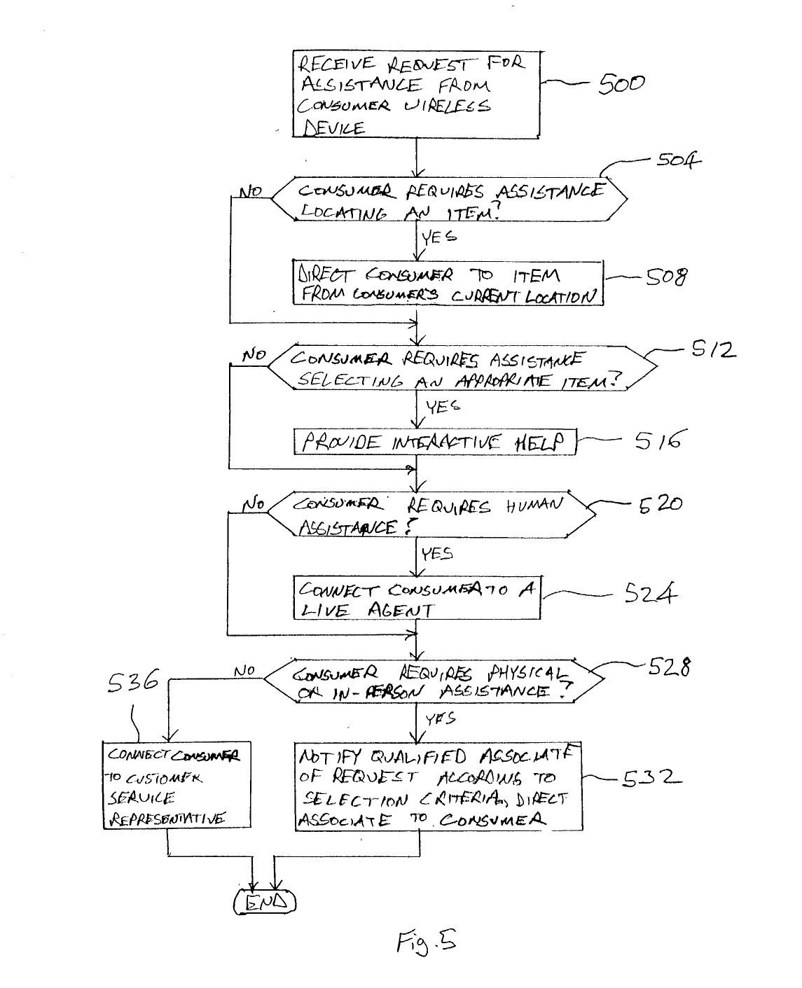

With reference now to FIG. 4, a flow chart illustrating the operation of a system 100 in accordance with an embodiment of the present invention is illustrated. Initially, at step 400, a consumer registers with the enterprise. For example, in connection with a consumer provided wireless device 120, the user may authorize the enterprise network infrastructure 104 to communicate with the consumer wireless device 120 when the consumer wireless device 120 is within the operating area of the enterprise network infrastructure 104.

As part of the registration process, the consumer may provide additional information about the consumer. For example, the consumer may indicate a language preference for communications between the consumer and associates of the enterprise. A language preference may also be used to select a language of information provided by, for example, the enterprise server 116 to the consumer via the consumer wireless device 120. The consumer may also authorize the enterprise to compile and utilize demographic information associated with the consumer in guiding communications between the enterprise and the consumer. In addition, the consumer may authorize the use of previous transaction information for assisting the enterprise in communicating with the consumer. Thus, the enterprise server 116 may store information related to a consumer, for example in a database 336 in the data storage 312, or have access to information maintained by another enterprise, for example over the Internet 128. As will be described in greater detail below, such information may be utilized by the enterprise in determining what information to provide to the consumer, and in directing a level of service provided to the consumer. Information and authority to use information may be provided to the enterprise electronically. For example, a consumer may provide information and/or authority to use information from a personal computer or a wireless device 120 interconnected to the enterprise server 116 via the Internet 128.

The step of consumer registration may additionally include steps taken by a consumer upon entering an enterprise site. For example, a consumer that does not have their own wireless device 120 may obtain one from the enterprise upon entering the enterprise site. As part of obtaining the wireless device 120, the consumer may be asked to provide certain information. For example, the consumer may indicate a language preference for communications between the consumer and the enterprise. In addition, the consumer may be asked to provide identifying information. Identifying information may be used to access records of previous transactions with the particular consumer, or to access information previously provided by the consumer, for example during a previous step of registration performed by the consumer from a home computer connected to the enterprise server 116 via the Internet 128 (see FIG. 1). Accordingly, it can be appreciated that the step of consumer registration 400 may comprise steps taken both before and at the time the consumer enters the enterprise site.

At step 404, the consumer enters the enterprise site. That is, the consumer enters the operating area of the enterprise network infrastructure 104. Alternatively, the step of entering the enterprise site 404 may comprise activating a consumer wireless device 120, or authorizing communications between the consumer wireless device 120 and the enterprise network infrastructure 104. The enterprise network infrastructure, for example the location monitor 316, then detects the presence of the consumer wireless device 120, and the system queries the consumer to confirm the consumer's identity (step 408). For example, where a consumer brings their own wireless device 120 into the operative area of the enterprise network infrastructure 104, the consumer may be queried to provide identifying information to confirm that the person carrying the consumer wireless device 120 is the person to whom that device is in fact registered. Where the person carrying the wireless device 120 is not the person to whom that device 120 is registered, the enterprise network infrastructure 104 may continue to communicate with the wireless device 120, but without the benefit of any demographic information that might be maintained by the enterprise network 104 in connection with the registered consumer. Alternatively, the person carrying the wireless device 120 may enter information identifying that consumer, and any demographic or other information maintained with respect to that consumer may be referenced in communicating with the consumer wireless device 120.

At step 412, a determination is made as to whether the consumer identification has been confirmed. If no identifying information is provided, or if no additional data is available to the enterprise network 104 in connection with the identified consumer, the system proceeds to step 416, where a determination is made as to whether the consumer has entered a request for assistance. If such a request is received, a response is provided to that specific consumer request (step 420). The system may then return to step 412 to allow for the possibility that identification information will eventually be provided.

If information identifying the consumer holding the wireless device is received, information tailored to that consumer may be pushed to the consumer wireless device 120 (step 424). For example, information tailored to that consumer, based on demographic information provided by the consumer or based on records of previous transactions between the enterprise and that consumer, may be used to tailor information pushed to the consumer. As another example, a consumer who purchased a particular item from the enterprise may be provided with information concerning additional items that complement the item previously purchased. For instance, accessories or repair parts may be suggested. Furthermore, the provision of such information may be unsolicited by the consumer, with the possible exception of requesting permission from the consumer to provide such information based on data maintained or available to the enterprise regarding that consumer. In addition, information pushed to the consumer may account for the location of the consumer within the enterprise site. For example, a consumer who has purchased a number of items from the enterprise in the past may be provided with suggested accessories or repair parts stocked in an area of the enterprise site at which the consumer is then located.

At step 428, a determination is made as to whether the location of the consumer has changed. If the consumer has moved, the system may return to step 424, and information tailored to the consumer's new location may be provided.

At step 432, a determination is made as to whether the consumer has made a request for assistance. For example, the consumer may indicate a need for assistance by pressing a help button displayed on a touch screen provided by the consumer wireless device 120. In response to a request for assistance, the consumer may be provided with available enhanced content (step 436). That is, as the consumer has confirmed their identity (at step 412), the enterprise may have available to it information that allows enhanced content to be provided. For instance, if the consumer indicates as part of the request for assistance a need for a consumable that is compatible with a device previously purchased from the enterprise by the consumer, the enterprise may suggest only those consumables that are compatible with the previously purchased item.

In general, the enterprise continually determines whether a consumer location has changed or whether the consumer has requested assistance while the consumer wireless device 120 is in communication with the enterprise network infrastructure 104.

With reference now to FIG. 5, a flow chart depicting the operation of a system 100 in response to a consumer's request for assistance entered using a consumer wireless device 120 is illustrated. Initially, at step 500, a request for assistance is received from a consumer wireless device 120 in communication with the enterprise network 104 (step 500). At step 504, a determination is made as to whether the consumer has indicated a need for assistance in locating an item. If such an indication has been received, the consumer is queried for information identifying the item, if such information has not already been provided.

The consumer is then directed to the requested item from the consumer's current location (step 508). In particular, the location of the wireless device 120 within the enterprise site is determined by the location monitor 316. Such location information may be obtained, for example, by reference to a particular antenna 108 with which the wireless device 120 is in communication. As a further example, the position of the consumer wireless device 120 within the enterprise site may be determined by reference to signal time of arrival information obtained in connection with three or more enterprise antennas 108. Having determined the location of the consumer within the enterprise site, detailed instructions directing the consumer to a requested item can be provided by referencing a database containing information concerning the location of items at the enterprise site. Furthermore, where a consumer has provided the enterprise network 104 with a number of required items, the consumer may be provided with directions to each item following the most efficient path to those items. If the particular enterprise site does not have an item immediately available, information concerning when the item could be available at the enterprise site may be provided. Alternatively or in addition, directions to another enterprise site that has the requested item in stock may be provided to the consumer through the consumer wireless device 120. An opportunity to order a requested item, the expected in-stock date, or an opportunity to request that a hold be placed on the requested item can also be offered to the consumer. Assistance with respect to a requested item may be provided by the automated assistant 324.

If the consumer does not indicate a need for assistance in locating an item, or after such assistance has been provided, a determination is made as to whether the consumer requires assistance in selecting an appropriate item (step 512). If the consumer has indicated a need for such assistance, the enterprise network 104 may provide interactive help (step 516). Such interactive help may include querying the consumer to provide as much information as the consumer can regarding the particular item needed. The enterprise network 104 may then use information or selections provided by the consumer to suggest a particular item or list of items that will meet the criteria provided by the consumer. Such interactive help may be provided by the automated assistant application 324 in the form of menus displayed to the user and selected using a pointing device. Accordingly, such interactive help may be provided through textual pages provided through a web browser application running on the consumer wireless device 120 and a web server application 332 running on the enterprise server 116 and operating in cooperation with the automated assistant application 324. Interactive help may also be available through an interactive voice recognition application 340 operating in cooperation with the automated assistant application 324. For example, a consumer using a consumer wireless device 120 comprising a wireless headset may navigate through help menus using spoken commands.

After providing interactive help, whether such help was successful or not, or if the consumer did not indicate a need for assistance in selecting an item, a determination may be made as to whether the consumer requires human assistance (step 520). If such a need is indicated, the consumer may be connected to a live agent (step 524). Such a connection may be provided in the form of a voice communication link made over the enterprise network infrastructure 104. Furthermore, the live agent may comprise an associate communicating using an associate wireless device 124 in communication with the enterprise network infrastructure 104. Alternatively, the live agent may comprise an agent interconnected to the enterprise network 104 by a wireline connection, for example through the PSTN 132.

Whether or not the live agent is successful in assisting the consumer, or if the consumer has not indicated a need to speak to a live agent, a determination is made as to whether the consumer requires physical or in-person assistance (step 528). For example, a consumer may require help in distinguishing between various items available from the enterprise, or may require help in reaching an item. In response to a request for such assistance, a qualified associate of the enterprise is notified of the request (step 532). The particular associate notified may be selected according to various criteria. For example, the language preference requirement indicated by a consumer may narrow the pool of associates from which a selection may be made. Additional qualifying parameters may include the location of an associate within the enterprise, the areas of expertise of the various associates, and whether an associate has been directed to assist another consumer or is presently assisting another consumer. With respect to location information of various associates, such information may be obtained by detecting the location of the associate wireless devices carried by the associates. Information concerning the availability of associates and their qualifications may be obtained by referencing, for example, a database 336 maintained on the enterprise server 116. Where a selected associate is not immediately available, a token representing the consumer may be placed in a queue maintained on the enterprise server 116 or the associate wireless device 124. For example, a request may be placed in a queue established by the resource distribution application 344. Where multiple associates are capable of assisting the consumer but none are immediately available, tokens representing the consumer may be placed in a queue or queues maintained with respect to a service class appropriate to the consumer's request or for each such associate.

After a qualified associate has been selected, or an associate becomes available, that associate is notified of the consumer's request (step 532). Such notification may be transmitted to the associate wireless device 124 for communication to the associate. The notification may include an indication of the consumer's location within the site. Alternatively or in addition, the notification may include directions to the consumer following the shortest path. If a token representing the consumer was placed in a queue associated with any associate other than the dispatched associate, the token is removed from that other queue.

If the consumer does not indicate a need for physical or in-person assistance, the consumer may be interconnected to a customer service representative to determine how best to respond to the consumer's unspecified request for assistance (step 536).

In addition to responding to requests for assistance, the present invention may be used in connection with maintaining a desired level of consumer contact. For example, the present invention may be used to ensure that consumers are greeted by an associate within a predetermined time of the consumer's arrival at the enterprise site. In addition, the way in which a consumer is contacted may be determined, at least in part, by reference to information held by the enterprise in connection with that consumer. For instance, an associate may be dispatched to personally greet a consumer who has made large purchases from the enterprise in the past.

As can be appreciated from the above description, the present invention is particularly useful in connection with assisting a consumer visiting a retail store. However, it should be appreciated that the invention is not so limited. For example, the invention may be adapted for use in connection with the operation of a warehouse. In such an application, associates may be directed to items that are to be retrieved for shipment or for sale to a consumer visiting the warehouse using an associate wireless device 124. For example, an associate located near a requested item may be tasked with retrieving that item and returning it to the sales office or shipping office. The information regarding the location of the associate may be obtained by determining the location of the associate wireless device 124. In addition, the associate wireless device 124 may be used to provide the associate with a list of required items, and may suggest the most efficient path for the associate to follow in retrieving the requested items. Accordingly, the present invention has application to improving the efficiency of warehouse operations, in addition to improving the provision of consumer assistance in retail operations.

The foregoing discussion of the invent ion has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A method for matching an associate to a consumer, comprising:
detecting a consumer presence on an enterprise site, wherein said step of detecting comprises:
detecting the initiation of communications between a consumer wireless communication device and a wireless network associated with said enterprise site;
acknowledging said consumer presence;
detecting a need to assist said consumer; and
providing a resource to said consumer.

2. The method of claim 1, further comprising:
detecting a location of said consumer within said enterprise site, wherein said resource provided to said consumer is selected in view of said detected location of said consumer.

3. The method of claim 2, wherein said location of said consumer is detected by detecting a location of said consumer wireless communication device.

4. The method of claim 1, further comprising:
receiving confirmation of said consumers identity; and
providing information to said consumer based on a profile maintained for said consumer.

5. The method of claim 1, wherein said resource provided to said consumer comprises interactive help provided to said consumer through said consumer wireless device.

6. The method of claim 5, wherein said interactive help comprises interactive voice recognition.

7. The method of claim 1, wherein said resource provided to said consumer comprises live help provided over a voice link provided through said consumer wireless device.

8. The method of claim 7, wherein said live help is provided by an associate operating an associate wireless device.

9. The method of claim 1, wherein said resource provided to said consumer comprises human assistance, and wherein an agent for providing said human assistance is directed to a detected location of said consumer within said enterprise site.

10. The method of claim 1, wherein said resource directs said consumer from a detected location of said consumer to a desired location.

11. The method of claim 10, wherein said desired location comprises at least one of a location of a desired item, a location of a qualified associate, and a location of a desired service.

12. A computer readable medium comprising instructions to perform the steps of claim 1.

13. A logic circuit operable to perform the steps of claim 1.

14. A system for matching a consumer to an on-site enterprise resource, comprising:
a wireless network;
a server computer in communication with said wireless network, comprising:
a data storage device for storing at least one of applications and data;
a processor;
software stored in said data storage device and operative on said processor for detecting the presence of a wireless device in communication with said wireless network; and
software stored in said data storage device and operative on said processor for providing said wireless device with data.

15. The system of claim 14, wherein said wireless network comprises a plurality of antennas.

16. The system of claim 14, further comprising:
software stored in said data storage device and operative on said processor for determining a location of said wireless device within said site.

17. The system of claim 14, further comprising:
a consumer wireless device, comprising:
a wireless interface, wherein said consumer wireless device is capable of communicating with said wireless network;
a user input device, wherein said consumer may provide input to said consumer wireless device; and
a user output device, wherein data received from said server computer through said wireless network is provided to said consumer.

18. The system of claim 17, wherein said user input device comprises at least one of a keyboard, a touch screen, a pointing device, and a microphone.

19. The system of claim 17, wherein said user output device comprises at least one of a visual display, and a speaker.

20. The system of claim 14, wherein said wireless network comprises a network utilizing a radio frequency link between said network and a wireless device.

21. The system of claim 14, further comprising:
an associate wireless device, comprising:
a wireless interface, wherein said associate wireless device is capable of communicating with said wireless network;
a user input device, wherein said associate may provide input to said associate wireless device; and
a user output device, wherein said associate is provided with data received from said server computer through said wireless network.

22. The system of claim 14, wherein said server computer comprises a software application for providing interactive help to a user of said wireless device.

23. The system of claim 22, wherein said interactive help comprises a voice recognition application, wherein said user of said wireless device uses voice commands to navigate through said interactive help.

24. A system for matching a consumer to an associate at an enterprise site, comprising:
means for detecting the presence of said consumer;
means for detecting a need of said consumer for assistance;
means for communicating said detected presence of said consumer and said detected need of said consumer for assistance to an enterprise server computer means; and
means for providing said consumer with said assistance, comprising at least one of means for communicating information from said enterprise server computer means to said consumer, means for establishing a communication link between said consumer and said associate, means for directing said consumer to a qualified associate, and means for directing said associate to a location of said consumer.

25. The system of claim 24, wherein said means for detecting comprises a means for determining a location of said consumer within said enterprise site.

26. The system of claim 24, wherein said means for detecting the presence of said consumer comprises a consumer wireless communication device means, and enterprise wireless network means.

27. The system of claim 24, wherein said means for establishing a communication link between said consumer and said associate, and said means for directing said associate to a location of said consumer comprises an associate wireless communication device means.
